(19) United States
(12) Patent Application Publication
(10) Pub. No.: US 2008/0059404 A1
(43) Pub. Date: Mar. 6, 2008

(54) Method of Searching in a Collection of Documents

(75) Inventors: Willem Jonker, Eindhoven (NL); Ling Feng, Enschede (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/565,927

(22) PCT Filed: Jul. 16, 2004
(86) PCT No.: PCT/IB04/51244

§ 371 Date: Jan. 20, 2006

(30) Foreign Application Priority Data
Jul. 21, 2003 (EP) 03102240.3

(51) Int. Cl. G06F 17/30

(52) U.S. Cl. 707/2; 707/E17.017

(57) ABSTRACT

The present invention relates to a method of searching in a collection of documents having a tree-like structure and complying with at least one document structure definition in a collection of document structure definitions. This method comprises the steps of receiving (1) a certain branch, determining (3) a subset of the collection of document structure definitions which allow the certain branch to exist in a document complying to the document structure definition, determining (5) a subset of the collection of documents which comprises all documents of the collection of documents complying to any one of the document structure definitions in the subset, and searching (7) for at least part of the certain branch in each document. The present invention further relates to a method of indexing a collection of documents for facilitating the method of searching in a collection of documents of the invention. The present invention also relates to computer program products enabling a programmable device to carry out the methods of the invention and to electronic devices for carrying out the methods of the invention.

The invention relates to a method of searching in a collection of documents, the documents having a tree-like structure and each document in the collection of documents complying with at least one document structure definition in a collection of document structure definitions, and in particular to a method comprising the steps of receiving a certain branch and searching for at least part of the certain branch in a collection of documents.

The invention further relates to a computer program product enabling a programmable device to carry out a method of searching in a collection of documents.

The invention also relates to an electronic device for searching in a collection of documents.

The invention further relates to a method of indexing a collection of documents, an in particular to a method enabling searching in a collection of structured documents.

The invention also relates to a computer program product enabling a programmable device to carry out a method of indexing a collection of documents.

The invention further relates to an electronic device for indexing a collection of structured documents.

An example of such a method of searching in a collection of documents is known from a World Wide Web Consortium standard called XPath. This standard describes searching for XML documents containing a certain path. XML documents have a tree-like structure, wherein each node has a tag and possibly a value. There is not more than one path between each two nodes. It is general practice to search for a path in XML documents by searching in each individual XML document. It is a drawback of the known method of searching in a collection of documents that a search may take a long time, especially if the documents are encrypted and need to be decrypted.

It is a first object of the invention to provide a method of searching in a collection of documents which enables a more efficient search.

It is a second object of the invention to provide a method of indexing a collection of documents which enables a more efficient search.

According to the invention, the first object is realized in that the method of searching in a collection of documents comprises the steps of receiving a certain branch, determining a subset of the collection of document structure definitions, each document structure definition in the subset allowing the certain branch to exist in a document complying to the document structure definition, determining a subset of the collection of documents, the subset of documents comprising all documents of the collection of documents complying to any one of the document structure definitions in the subset, and searching for at least part of the certain branch in each document. A branch may start or end at more than one node. Both a path and a branch comprise one or more tags and a path is also a branch. A path may, for example, be represented like ‘book/name’ or ‘book.name’. A branch may, for example, be represented by ‘book/name’, ‘book.name’, or ‘book(name+author(name+age))’. A branch may be represented by a plurality of paths, like, for example, {‘book.name’, ‘book.author.name’, book.author.age’}. A document may for example be an XML or an SGML document. A document structure definition may for example be an XML Data Type Definition (DTD) or an XML schema. By using the document structure definition to determine a set of candidate documents, a search is made more efficient. It is no longer necessary to search in all the documents.

In an embodiment of the method of searching in a collection of documents of the invention, a further step comprises attempting to decrypt each encrypted document in the subset of documents. Unnecessary decryption of encrypted documents is reduced, as not all encrypted documents have to be decrypted, but only encrypted documents in the subset.

The step of determining a subset of the collection of documents may comprise calculating a number for at least part of the certain branch by applying a hash function to the at least part of the certain branch and looking up which documents are mapped to the calculated number in a mapping from number to documents, the mapping being associated with a document structure definition of the subset of document structure definitions and the documents in the mapping complying to the document structure definition. This not only provides security (the mapping does not show which branch is present in which document), but also enables efficient document look-up. The size of the hash mapping (and most likely the maximum number returned by the hash function) may be adapted based on the collection of documents.

Alternatively, instead of storing hashes of branch names, the branch names themselves could be stored in a mapping from branch names to documents. This also enables a more efficient search in comparison with a search without using an index, but is less advantageous than using a hash mapping. To provide security, extra measures would have to be taken. To ensure that a branch does not unambiguously map to a document, a branch may have to be mapped to documents that do not contain the branch. This makes the search even less efficient, but provides some degree of confidentiality.

The method may comprise a further step of receiving a certain value associated with the certain branch. The mapping may further comprise an association between a document in the mapping and a value domain partition. The step of determining a subset of the collection of documents may further comprise checking whether a value domain partition associated to a document mapped to the calculated number matches a further value domain partition, the further value domain partition comprising the received value. Security is provided by placing only a value domain partition in the mapping and not a value. The value domain partition only gives a weak indication of possible values, but does enable a more efficient search. A value domain partition may for example be ‘a-e’, ‘a,b,c,d,e’, ‘1-5’, ‘1,2,3,4,5’, ‘Europe’, or ‘Netherlands, Germany, France, . . . ’.

The step of determining a subset of the collection of documents may comprise looking up, in a mapping from document structure definition to documents, which documents comply to any one of the subset of document structure definitions. Advantageously, a mapping from document structure definition to documents can easily be created manually (e.g. using a text editor), as it is not necessary to create a mapping for each document structure definition or to associate a document with a value domain partition.

The step of determining a subset of the collection of document structure definitions comprises calculating a further number for at least part of the certain branch by applying a further hash function to the at least part of the certain branch and looking up which document structure definitions are mapped to the calculated number in a mapping from number to document structure definitions. A hash mapping (e.g. in the form of a hash table) makes the step of determining a subset of the collection of document structure definitions more efficient, because it is no longer necessary to decrypt document structure definitions. A hash mapping also provides security, as the hash mapping does not reveal which branch is present in which document structure definition.

The step of determining a subset of the collection of document structure definitions may comprise attempting to decrypt each encrypted document structure definition in the collection of document structure definitions and attempting to determine for each document structure definition whether the document structure definition allows the certain branch to exist in a document complying to the document structure definition. The amount of indexing can thus be limited by using, for example, existing XML DTD or Schema files in a search. The XML DTD or Schema files may be represented, for example, by a tree in memory before the actual search is performed. The tree may be traversed to determine whether the XML DTD allows the certain branch to exist in an XML document complying to the XML DTD.

In another aspect of the invention, an electronic device for searching in a collection of documents comprises electronic circuitry functionally comprising an input receiver for receiving a certain branch, a definition subset determiner for determining a subset of a collection of document structure definitions, each document structure definition in the subset allowing the certain branch to exist in a document complying to the document structure definition, a document subset determiner for determining a subset of a collection of documents, the subset of documents comprising all documents of the collection of documents complying to any one of the document structure definitions in the subset, and a searcher for searching for at least part of the certain branch in each document.

According to the invention, the second object is realized in that the method of indexing a collection of documents comprises the steps of creating an empty index for each document structure definition of the collection of document structure definitions, the index mapping each integer from a range of integers to a document of the collection of documents, calculating a number for at least a part of a branch in a document of the collection of documents by applying a hash function to the at least part of the branch, the number being limited to the range of integers and the calculation possibly producing a same number for different branches, and creating an entry in an index for a document structure definition to which said document complies, the entry comprising a mapping from said calculated number to said document comprising the at least part of the branch. This not only provides security (the index does not show which branch is present in which document), but also enables efficient document look-up (it is not necessary to retrieve/read each document complying to a candidate document structure definition).

In an alternative method of indexing a collection of documents, one index mapping from all document structure definitions to documents may be created instead of multiple indices mapping from one document structure definition to documents. This one index may be, for example, a hash table, which can provide both security and efficiency. The alternative range of integers used in such a table will most likely be larger than said range of integers or said further range of integers.

In an embodiment of the method of indexing a collection of documents of the invention, creating an entry in the index comprises associating the document in the mapping to a value domain partition, the value domain partition comprising a value associated with the branch.

The method may comprise a further step comprising creating an empty further index in which each integer from a further range of integers can be mapped to a document structure definition, a further step comprising calculating a further number for at least part of said branch by applying a further hash function to said branch, the further number being limited to the further range of integers and the calculation possibly producing a same further number for different branches, and a further step comprising creating an entry in the further index, the entry in the further index comprising a mapping from the calculated further number to said document structure definition to which said document complies.

In another aspect of the invention, an electronic device for indexing a collection of documents comprises electronic circuitry functionally comprising an index creator for creating an empty index for each document structure definition of a collection of document structure definitions, the index mapping an integer from a range of integers to a document of the collection of documents, a hash calculator for calculating a number for at least a part of a branch in a document of the collection of documents by applying a hash function to the at least part of the branch, the number being limited to the range of integers and the calculation possibly producing a same number for different branches, and an index filler for creating an entry in an index for a document structure definition to which said document complies, the entry comprising a mapping from said calculated number to said document comprising the at least part of the branch.

These and other aspects of the electronic device and method of the invention will be further elucidated and described with reference to the drawings, in which:

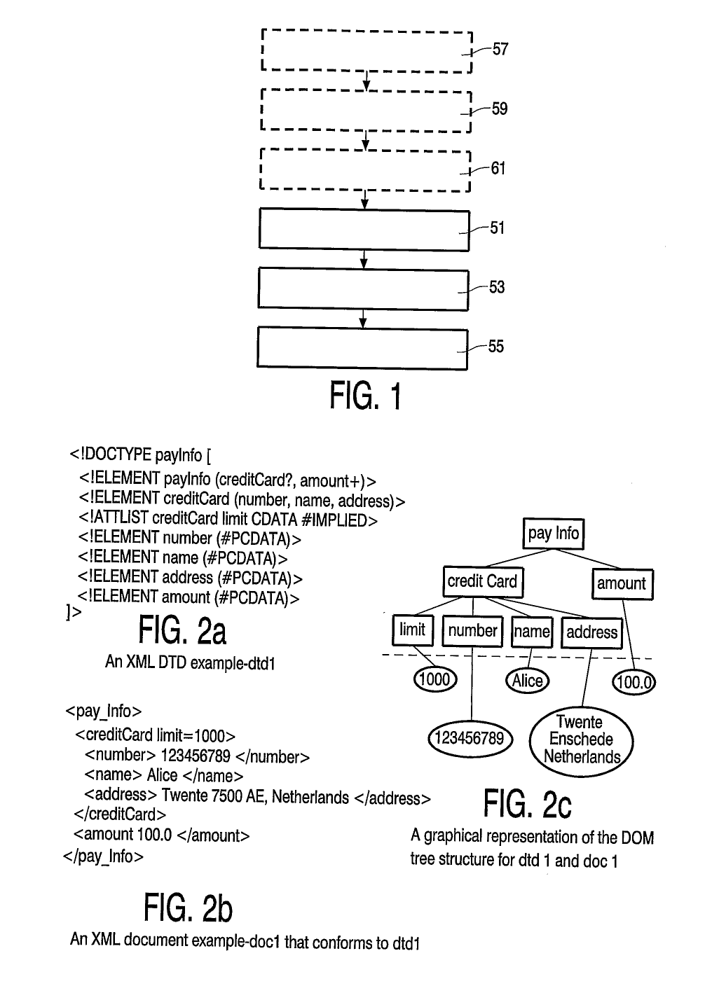

FIG. 1 is a flow chart of the method of indexing a collection of documents in accordance with the invention;

FIG. 2 shows a first document example and a corresponding first DTD example;

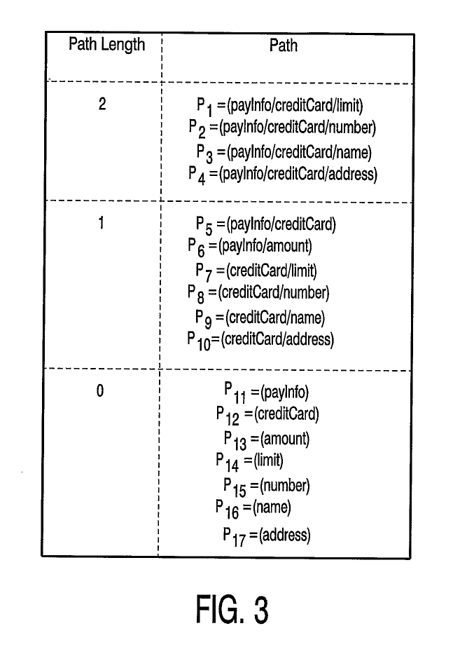

FIG. 3 is a table comprising paths extracted from the first DTD example;

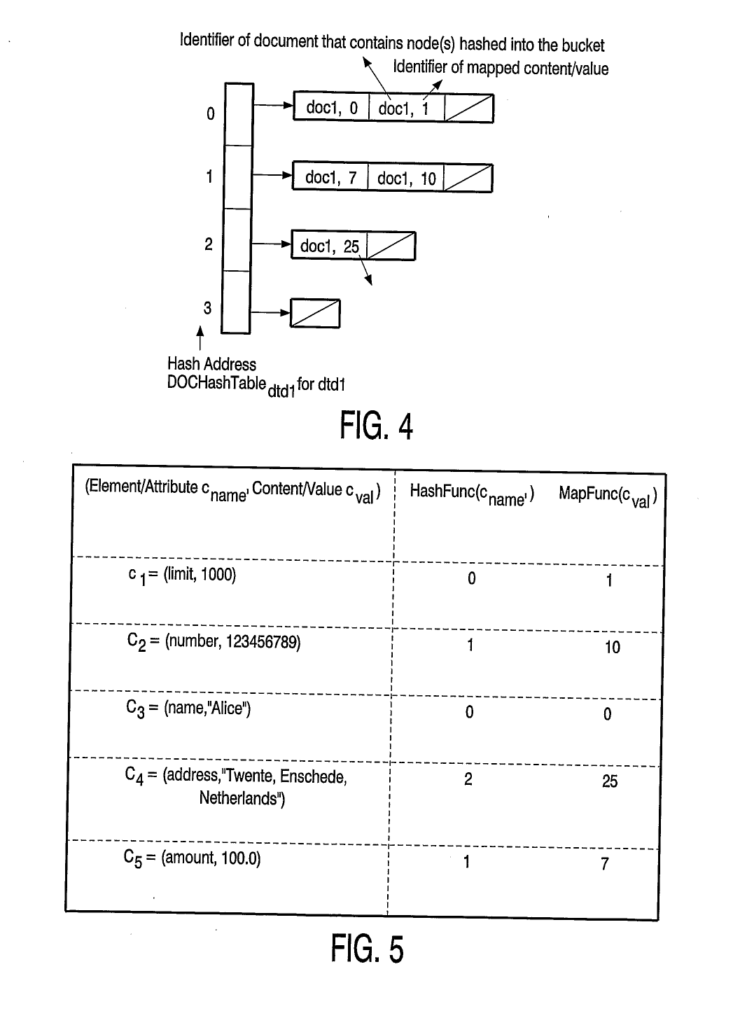

FIG. 4 shows an example of an index;

FIG. 5 is a table comprising value domain partitions of the first document example;

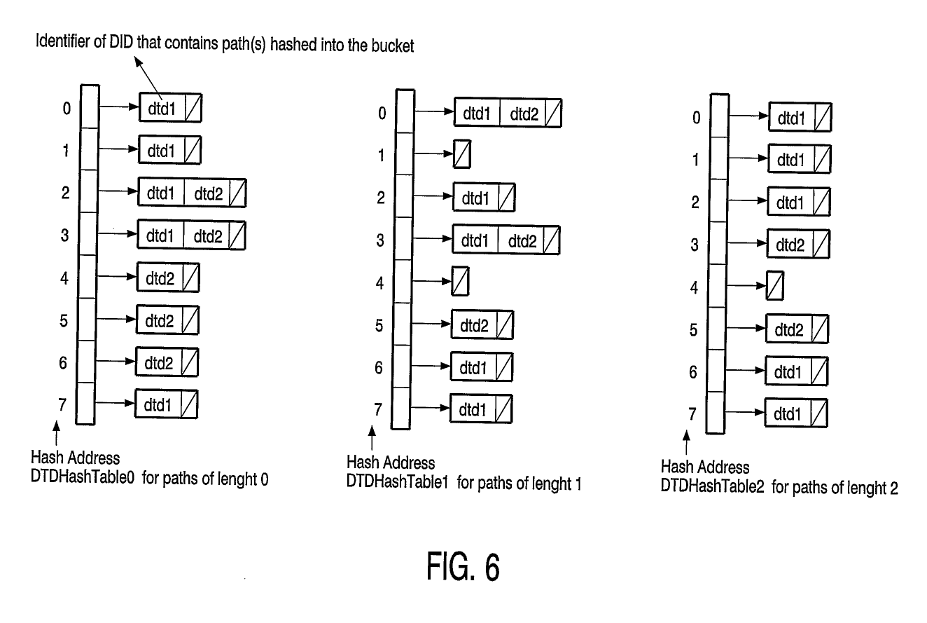

FIG. 6 shows an example of a further index;

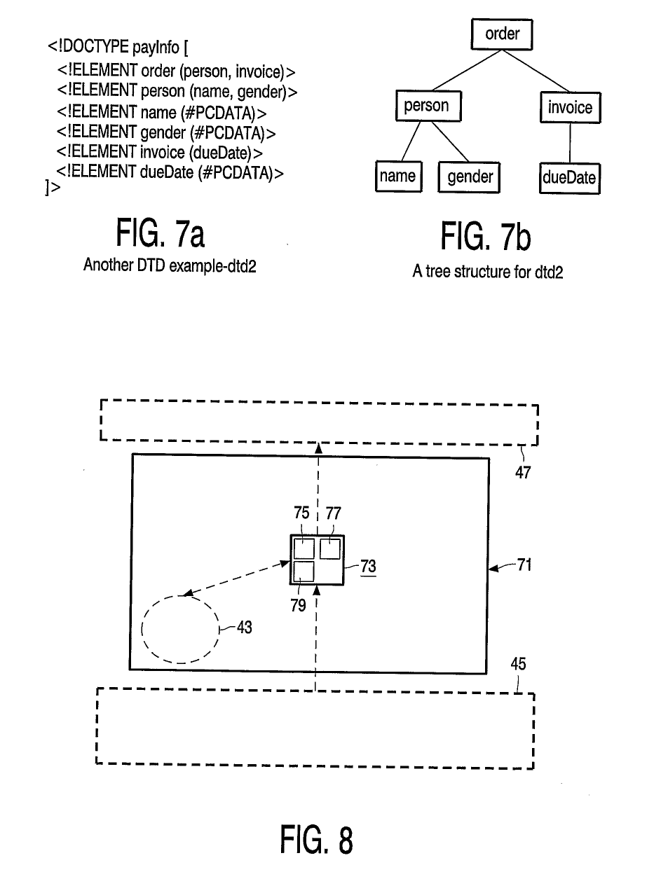

FIG. 7 shows a second DTD example;

FIG. 8 is a block diagram of an electronic device for indexing a collection of documents in accordance with the invention;

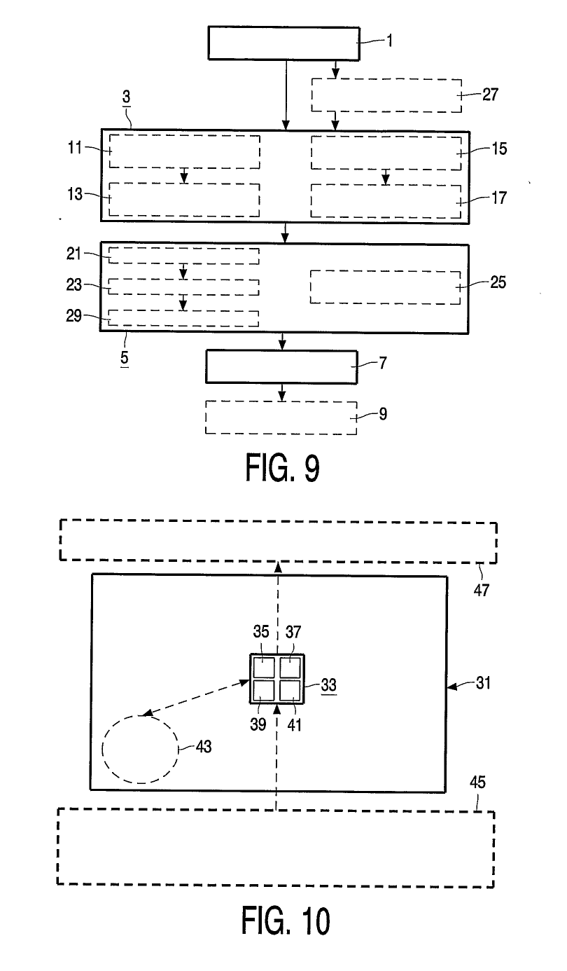

FIG. 9 is a flow chart of the method of searching in a collection of documents in accordance with the invention;

FIG. 10 is a block diagram of an electronic device for searching in a collection of documents in accordance with the invention.

Corresponding elements within the drawings are identified by the same reference numeral.

The method of indexing a collection of documents in accordance with the invention is shown in FIG. 1. The method comprises at least three steps. Step 51 comprises creating an empty index for each document structure definition of the collection of document structure definitions, the index mapping an integer from a range of integers to a document of the collection of documents. Step 53 comprises calculating a number for at least a part of a branch in a document of the collection of documents by applying a hash function to the at least part of the branch, the number being limited to the range of integers and the calculation possibly producing a same number for different branches. Finally, step 55 comprises creating an entry in an index for a document structure definition to which said document complies, the entry comprising a mapping from said calculated number to said document comprising the at least part of the branch.

Documents, e.g. XML documents, that conform to one document structure definition, e.g. an XML DTD or an XML Schema, possess a similar structure, but with possibly different element contents and/or attribute values to distinguish different documents. For instance, the conforming document doc₁ of dtd₁ shown in FIG. 2 has a limit attribute of value 1000, represented as limit=1000 for simplicity. Its elements number, name, address and amount have contents 123456789, “Alice”, “Twente, Enschede, Netherlands” and 100.0, respectively.

An XML DTD or an XML Schema defines the legal building blocks of its conforming XML documents, like what elements, attributes, etc. are permitted in the documents. These components construct a hierarchical tree structure that underlies the contents of the documents, with each path of the tree addressing a certain part of a document. The notions of path and path length are defined as follows:

Definition 1. A path p is a sequence of nodes n₁, n₂, . . . , nₖ, denoted as p=(n₁/n₂/ . . . /nₖ), where for any two consecutive nodes, nᵢ and nᵢ₊₁ (1≦i≦k−1, k≧1), there exists an edge between them.

The length of path p, denoted as |P|, is the total number of edges in the path. That is, |p=(n₁/n₂/ . . . /nₖ)|=k−1.

FIG. 3 lists the paths of various lengths, extracted from the example DTD dtd₁ in FIG. 2. Here, the content nodes under the dotted line are exempt from consideration, since they do not appear in dtd₁.

Indexing the collection of documents may comprise building a document hash table DOCHashTable_{dtd1} for each dtd₁. In FIG. 4, each pair from dtd₁, c=(C_{name,} cᵥₐₗ) (where cₙₐₘₑ denotes an element/attribute, and cᵥₐₗ denotes the corresponding element content/attribute value) is encoded into the hash table DOCHashTable_{dtd1}, (alternatively, cₙₐₘₑ is encoded into the hash table DOCHashTable_{dtd1} without cᵥₐₗ). The hash address of each pair is calculated via function HashFunc(p) (Algorithm 1), but using a hash table size SizeDOCHashTable_{dtd1} rather than SizeDTDHashTable_{|p|}. The same hash function can be used to create hash tables for document structure definitions. In this example, path p always contains only one node, which is p=(cₙₐₘₑ) and |p|=0. For example, let s=4, and the size of hash table SizeDOCHashTable_{dtd1}, equal to 4 (i.e., SizeDOCHashTable_{dtd1}=4). This results in: ChopName(“limit”)=“limi”, Base26ValueOf(“limi”)=11*263+8*262+12*26+8=199064, and HashFunc(limit)=199064*10⁰ mod 4=0.

Algorithm 1 Hash function HashFunc(p)

Input: path p=(n₁/n₃/ . . . /nₖ), a fixed size s for node names,
hash table size SizeDTDHashTable_{|p|};

Output: hash value of p
a) For each node nᵢ (1≦i≦k), chop its name uniformly into an s-letter string

ChopName (nᵢ, s)=x_{n 1,1}x_{n 1,2} . . . x_{n i,s} where x_{n 1,1}, x_{n 1,2} , . . . , x_{n i,s} are letters in the name string of node n.
b) For each s-letter node name x_{n ,1,1}x_{n 1,2} . . . x_{n i,s}, convert it into a decimal integer

Base26ValueOf(x_{n 1,1}x_{n 1,2} . . . x_{n i,s})=offset(x_{n 1,1})*26^{s-1}+offset(x_{n 1,2})*26^{s-2}+. . . +offset(x_{n i,s})*26⁰=V_{n i}, where offset(x _{n i,j})(1≦j≦s) returns the position of letter x_{n i,j} among 26 letters.
c) Compute hash value of p=(n₁/n₂/ . . . /nₖ)

HashFunc(n₁/n₂/ . . . /nₖ)=Vₙ₁*10^{k-1}+Vₙ₂*10^{k-2} + . . . +Vₙₖ*10⁰) mod SizeDTDHashTable_{|p|}

Algorithm 1 elaborates the procedures in computing the hash value for path p=(n₁.n₂/ . . . /nₖ). It proceeds in the following three steps:

First, node names in path $p$ which could be of different lengths are uniformly chopped into the same size s, given by users as an input parameter, through the function ChopName (Algorithm 1, Step a). For example, let s=4, ChopName(“creditCard”, 4)=“cred”, ChopName(“payInfo”, 4)=“pays”, ChopName(“name”, 4)=“name”.

Second, the chopped node name strings, which are of a fixed size after Step a, are further converted into decimal integers via function Base26ValueOf (Algorithm 1, Step b). Example 1 shows how it works when the size of node name string is set to 4.

### EXAMPLE 1

When a 4-letter node name x₁x₂x₃x₄, which are case insensitive, represents a base-26 integer, the letter ‘a’ represents the digit-value 0, the letter ‘b’ represent the digit-value 1, the letter ‘c’ represent the digit-value 2, the letter ‘d’ represent the digit-value 3, and so on, up until the letter ‘z’ which represents the digit-value 25. Given a letter, function “offset” returns such a digit-value. The 4-letter node name x₁x₂x₃x₄ can thus be converted into a decimal integer using the formnula:

Base26ValueOf(x₁x₂x₃x₄)=offset(x₁)*26³+offset(x₂)*26²+offset(x₃)*26¹+offset(x₄)*26⁰

Assume that x₁x₂x₃X₄=“name”, since the digit-values of ‘n’, ‘a’, ‘m’ and ‘e’ are offset(‘n’)=13, offset(‘a’)=0, offset(‘m’)=12, and offset(‘e’)=4 respectively. Base26ValueOf(“name”)=13*26³+0*26²+12*26¹+4*26⁰13*17576+0+312+4=228802. In a similar way, Base26ValueOf (“cred”)=2*26³+17*26²+4*26¹+3*26⁰=2*17576+17*676+104+3=35152+11492+104+3=46751. A general calculation of Base26ValueOf is:

Base26ValueOf(x₁x₂ . . . xₛ)=offset(x₁)*26^{s-1}+offset(x₂)*26^{s-2}+ . . . +offset(x^{s})*26⁰.

Finally, hash function HashFunc derives the hash value of path p=(n₁/n₂/ . . . /nₖ) based on the value Vₙᵢ returning from function Base26ValueOf on each node nᵢ (Algorithm 1, Step c).

HashFunc(n₁/n₂/ . . . /nₖ)=(Vₙ₁*10^{k-1}+Vₙ₂*10^{k-2}+ . . . +Vₙₖ*10⁰) mod SizeDTDHashTableₖ₋₁

### EXAMPLE 2

Given a path p=(creditCard/name) where k=2 and |p|=1, let s=4 and SizeDTDHashTable_{|p|}=SizeDTDHashTable₁=8.

Step 1: ChopName(“creditCard”, 4)=“cred”, ChopName(“name”, 4)=“name ”.

Step 2: Base26ValueOf(“name”)=228802, Base26ValueOf(“cred”)=46751.

$$Step 3 \text{:}$$

$$\begin{matrix}HashFunc ( ceditCard \text{/} name ) = ( Base 26 ValueOf ( “ cred ” ) * \\ {10}^{1} + Base 26 ValueOf ( “ name ” ) * \\ {10}^{\hat{} 0} ) \\ mod {SizeDTDHashTable}_{1} \\ = ( 46751 * 10 + 228802 ) mod 8 \\ = 0\end{matrix}$$

Creating an entry in the index may comprise associating the document in the mapping to a value domain partition, the value domain partition comprising a value associated with the branch. After calculating the number for the at least part of the branch (e.g. cₙₐₘₑ) of the document and mapping the document to the number, the document can be associated with a value domain partition. For example, the value domain partition is put into the same bucket as the document identifier, see FIG. 4. In this example, see FIG. 4 and FIG. 5, only the node part of the path is hashed. The entry to be put into the bucket can be computed based on cₙₐₘₑ and cᵥₐₗ, using the technique developed in “H. Hacigümüs, B. Lyer, C. Li, and S. Mehrotra. Executing SQL over encrypted data in the database-service-provider model. In Proc. the ACM SIGMOD Intl. Conf. on Management of Data, pages 216-227, Wisconsin, USA, June 2002”. The basic idea is to first divide the domain of node cₙₐₘₑ into a set of complete and disjoint partitions. That is, these partitions taken together cover the whole domain; and any two partitions do not overlap. Each partition is assigned a unique integer identifier. The value cᵥₐₗ of element/attribute node cₙₐₘₑ is then mapped to an integer, corresponding to the partition where it falls. For example, the domain of attribute limit can be partitioned into [0, 500], (500, 1000], (1000, ∞) of identifier 0, 1, 2, respectively. The limit value 1000 is thus mapped to integer 1, and stored in the first bucket of DOCHashTable_{dtd1}, since HashFunc(limit)=0. The hash values for other pairs in the example document are calculated in the same way, which are shown in FIG. 5.

Note that the partition of a domain can be done based on the semantics of data and relevant applications. For instance, the domain of element name can be categorized according to the alphabetical order. The domain of element address can be partitioned according to province or country where located. Order preserving constraint can be enforced on such a mapping “MapFunc: domain (cₙₐₘₑ)→Integer”, which means that for any two values cᵥₐₗ₁ and cᵥₐₗ₂ in the domain of cₙₐₘₑ, if (cᵥₐₗ₁≦cᵥₐₗ₂), then MapFunc(cᵥₐₗ₁)≦MapFunc(cᵥₐₗ₂).

Assume the mapping functions for number, name, address and amount return identifiers, as indicated in FIG. 5. FIG. 4 plots the resulting encoding, i.e., DOCHashTable_{dtd1}, for the example XML document doc₁. All documents that conform to one DTD share the same document hash table. The collision pairs are linked together underneath the bucket at the collision hash address.

The method of indexing a collection of documents may comprise further steps 57, 59 and 61. These steps may be performed before, after, or in parallel to steps 51, 53 and 55. Step 57 comprises creating an empty further index in which each integer from a further range of integers can be mapped to a document structure definition. Step 59 comprises calculating a further number for at least part of said branch by applying a further hash function to said branch, the further number being limited to the further range of integers and the calculation possibly producing a same further number for different branches. Step 61 comprises creating an entry in the further index, the entry in the further index comprising a mapping from the calculated further number to said document structure definition to which said document complies.

Favorably, paths of different lengths can be hashed into different indexes. For example, paths of different lengths can be hashed into different hash tables named DTDHashTable₀, DTDHashTable₁, DTDHashTable₂, . . . , DTDHashTable_{max—pathLen}, respectively, see FIG. 6. All paths of length l (where 1≦l≦max_pathLen), no matter which DTD it comes from, will share one single hash table DTDHashTable₁, with each bucket indicating a set of DTDs, whose paths have been hashed into the bucket. Suppose there is a path p extracted from dtd₁, the hash function HashFunc(p) (Algorithm 1) computes its hash value, i.e., bucket address in the hash table DTDHashTable_{|p|}. Underneath the corresponding bucket, the identifier of dtd₁ is linked, signifying the DTD where p locates. In order to provide a more complete overview on the hash-based encoding method, another DTD example dtd₂ is shown in FIG. 7. In FIG. 6, all the paths from dtd₁ and dtd₂ with their corresponding DTDs marked in the respective buckets are hashed using the same hash function. Of course, it is also possible to hash paths of different length in the same index.

The electronic device 71 for indexing a collection of documents in accordance with the invention, see FIG. 8, comprises electronic circuitry 73. The electronic circuitry 73 functionally comprises an index creator 75, a hash calculator 77, and an index filler 79. The index creator 75 is operative to create an empty index for each document structure definition of a collection of document structure definitions, the index mapping an integer from a range of integers to a document of the collection of documents. The hash calculator 77 is operative to calculate a number for at least a part of a branch in a document of the collection of documents by applying a hash function to the at least part of the branch, the number being limited to the range of integers and the calculation possibly producing a same number for different branches. The index filler 79 is operative to create an entry in an index for a document structure definition to which said document complies, the entry comprising a mapping from said calculated number to said document comprising the at least part of the branch.

The electronic device 71 may be, for example, a computer or a consumer electronic device. The logic circuitry may be, for example, a general-purpose CPU (e.g. an AMD Athlon or Intel Pentium CPU) operative to run computer programs. Favorably, the index creator 75, the hash calculator 77, and the index filler 79 are functional components of a computer program. The electronic device 71 may be coupled to an input device 45, e.g. a keyboard, for configuring the electronic device 71 and/or for initiating the indexing process, for example. The electronic device 71 may be coupled to an output device 47, e.g. a CRT or LCD monitor, for configuring the electronic device 71 and/or for manually verifying the index, for example. The electronic device 71 may comprise a storage means 43. The storage means 43 may comprise, for example, one or more hard disks and/or one or more optical discs. The storage means 43 may comprise, for example, the created index, document structure definitions (e.g. XML DTDs and/or XML Schemas) and documents (e.g. XML documents). The electronic device 71 may be connected to a computer network comprising one or more electronic devices with storage means for storing the created index, one or more document structure definitions and/or one or more documents.

The method of searching in a collection of documents in accordance with the invention is shown in FIG. 9. The method comprises at least four steps. Step 1 comprises receiving a certain branch. Step 3 comprises determining a subset of the collection of document structure definitions, each document structure definition in the subset allowing the certain branch to exist in a document complying to the document structure definition. Step 5 comprises determining a subset of the collection of documents, the subset of documents comprising all documents of the collection of documents complying to any one of the document structure definitions in the subset. Finally, step 7 comprises searching for at least part of the certain branch in each document. The certain branch may be, for example, an XPath expression which was input on a keyboard by a user and converted into a path.

The XPath language is a W3C proposed standard for addressing parts of an XML document. It treats XML documents as a tree of nodes corresponding to elements/attributes, and offers an expressive way to specify and locate nodes within this tree.

XPath expressions state structural patterns that can be matched to paths, consisting of a sequence of nodes in the XML data tree. Such paths can be either absolute paths from the root of the data tree, or relative one starting with some known context nodes. The hierarchical relationships between the nodes are specified in XPath expressions using parent-child operator (“/”) and ancestor-descendant operator (“//”). For example, the XPath expression “/payInfo/creditCard/@limit” addresses limit attribute of creditCard which is a child element of the payInfo root element in the document. The name element in the relative path expression “//creditCard/name” is a child relative to its parent creditCard element. The expression “/payInfo//name” addresses name descendant element of the payInfo root element.

XPath also allows the use of a wildcard operator (“*” or “@*”), which can match any element or attribute node with respect to the context node in the document data tree. In addition, predicates, enclosed in square brackets (“[ ]”), can be applied to further refine the selected set of nodes in XPath expressions. For example, “/payInfo/creditCard[@limit<1000]/name” selects the name element of the XML document if the attribute limit of creditCard has a value less than 1000.

Operators like (“|”) and (“and”) can also be applied to select constituent nodes of paths. For instance, “/payInfo/(creditCard/cash)/name” expression selects every name element that has a parent that is either a creditCard or a cash element, that in turn is a child of a root element payInfo. On the contrary, “/payInfo/creditCard[@limit and @dueDate]” indicates all the creditCard children of the root element payInfo must have both a limit attribute and a dueDate attribute.

The XPath expression e, which is used to locate parts of a data tree, needs to be matched to a set of paths through the following three steps:
Step a

Decompose XPath expression e into several ones at the point of “//” operator.

Since paths to be encoded during the off-line query preparation phase have only parent-child relationships (“/”) between consecutive nodes (as shown in FIG. 3), an XPath expression needs to be broken from the points where the “//” operator locates, into several ones where each node, except for the first one, is prefixed only by “/”. The resulting XPath expressions thus contain no ancestor-descendant relationships (“//”) between every two consecutive nodes.

### EXAMPLE 3

An XPath expression e=“/payInfo[amount>100]//name” can be decomposed into two shorter XPath expressions e₁′=“/payInfo[amount>100]” and e₂′=“//name”. We use e [symbol] ₁e₁′Λe₂′ to denote such a semantically equivalent decomposition.

For ease of explanation, the XPath expressions are derived after Step a using a prime symbol like e′. They form the input of Step b.
Step b

Simplify predicate constraints in each XPath expression e′ to only hierarchical relationships.

As DTD encoding relieves value constraints on path nodes, and focuses only on their hierarchical relationships, to facilitate candidate DTD filtering, value constraints on nodes like “[amount>100]” and “[@limit=1000]”, specified in XPath predicate conditions, can be restrained and keep only their inherent parent-child or element-attribute relationships.

### EXAMPLE 4

The predicate constraint in e₁′=“/payInfo[amount>100]” implies that amount is a child element of payInfo, whose value constraint is eliminated by augmenting a parent-child relationship between payInfo and amount, resulting in a more relaxed XPath expression e₁″=“/payInfo/amount” after Step 2. [symbol] ₂ is used to denote such a simplification transformation, i.e., e₁″ [symbol] ₂ e₁″.

### EXAMPLE 5

A predicate situated in the intermediate of an XPath expression like “/payInfo[amount>100]/creditCard” leads to two XPath expressions being generated after Step b, which are “/payInfo/amount” and “/payInfo/creditCard”. That is, “/payInfo[amount>100]/creditCard” [symbol] ₂“/payInfo/amount” Λ “/payInfo/creditCard”.

e″ denotes an XPath expression returned after Step b.
Step c

Eliminate logical “|” and “and” operators in each XPath expression e″ by rewriting the expression into several ones logically connected with “Λ” or “V”.

To match the notion of path in Definition 1, every XPath expression after Step b containing the logical operators “|” and “and” is substituted by a set of shorter XPath expressions, which are logically connected via “Λ” or “V”.

### EXAMPLE 6

The XPath expression e″=“/payInfo/(creditCard|cash)name” can be viewed as two disjunctive expressions: e₁′″=“/payInfo/creditCard/name” and e₂′″=“/payInfo/cash/name”, denoted as e″ [symbol] ₃e₁′″Ve₂′″.

Similarly, the expression “/payInfo/creditCard[name and dueDate]” can be equally transformed into “/payInfo/creditCard/name” Λ “/payInfo/creditCard/dueDate”.

After undergoing the above three steps, an original XPath expression is transformed into a set of simple XPath expressions, each of which contains no ancestor-descendant relationship between every two consecutive nodes, no value constraints on nodes, and no logical operators (“|”) and (“and”).

### EXAMPLE 7

From an original XPath expression containing a predicate constraint and operator (“|”) like “/payInfo[amount>100]/(creditCard|cash)/name”, three simple XPath expressions: “/payInfo/amount” Λ (“/payInfo/creditCard/name” V “/payInfo/cash/name”) can be derived.

On the basis of simple XPath expressions generated from XPath query expressions, the concepts of candidate DTDs and documents for a given query can be defined. An XML DTD is called a candidate DTD for a query, if for every simple Xpath expression derived from the query, there possibly exists a path p in the DTD, that matches this simple XPath expression. In a similar fashion, an XML document can be defined to be a candidate document for a query, if and only if: 1) its DTD is a candidate DTD; and 2) it possibly satisfies all predicate constraints enforced on the nodes in the XPath query expression.

The method of searching in a collection of documents may further comprise a step 9 of attempting to decrypt each encrypted document in the subset of documents. Candidate DTDs may be decrypted using password or public-key-infrastructure based decryption techniques, for example.

Step 3 of determining a subset of the collection of document structure definitions may comprise a step 11 of calculating a further number for at least part of the certain branch by applying a further hash function to the at least part of the certain branch and a step 13 of looking up which document structure definitions are mapped to the calculated number in a mapping from number to document structure definitions. For example, to filter out non-candidate DTDs for a query, the hash values for all XPaths in the query can be computed using the same hash function, and then the corresponding buckets in the DTD hash tables, see for example FIG. 6, can be checked to obtain a subset of DTDs that possibly contain the requested paths. These DTDs are candidate DTDs to be considered for the query.

After pre-selecting the candidate DTD set for the given query, candidate documents can now be filtered out for each candidate DTD. At this stage, various value constraints in the form of [cₙₐₘₑ θ cᵥₐₗ], (where cₙₐₘₑ denotes the name of an element/attribute node, θ is one of the operators in {=, ≠, <, ≦, >, ≧}, and cᵥₐₗ denotes the element content/attribute value), on path nodes are taken into consideration. Clearly, a candidate document must not violate any of the value constraints specified within the XPath query expression.

Taking the constraint [cₙₐₘₑ θ cᵥₐₗ] for example, the node name cₙₐₘₑ (i.e., a path containing only one node) is first hashed into DOCHashTable_{dtd1} via hash function HashFunc(cₙₐₘₑ). Meanwhile, the range identifier of cᵥₐₗ is also calculated using the order preserving function MapFunc(cᵥₐₗ). Finally, each entry value ν linked to the bucket address HashFunc(cₙₐₘₑ) in DOCHashTable_{dtd1} is compared: if ∃ν (ν θ MapFunc(cᵥₐₗ)), then the constraint [cₙₐₘₑ θ cᵥₐₗ] possibly holds. The associated document where ν resides is then returned as the candidate document.

### EXAMPLE 8

Assume a query embeds an XPath expression “/payInfo/creditCard [@limit>2000]/name”, which enforces a constraint [@limit>2000] on creditCard element. Referring to the index in FIG. 4, where s=4 and SizeDOCHashTable_{dtd1}=4. Since all the mapped values at address 0 (=HashFunc(limit)) in DOCHashTable_{dtd1} are either 1 or 0, which is not greater than 2 (=MapFunc(2000)), therefore, the example document is not a candidate document for this query, and can thus be discarded.

Step 3 of determining a subset of the collection of document structure definitions may comprise a step 15 of attempting to decrypt each encrypted document structure definition in the collection of document structure definitions and a step 17 of attempting to determine for each document structure definition whether the document structure definition allows the certain branch to exist in a document complying to the document structure definition.

Step 5 of determining a subset of the collection of documents may comprise a step 21 of calculating a number for at least part of the certain branch by applying a hash function to the at least part of the certain branch and a step 23 of looking up which documents are mapped to the calculated number in a mapping from number to documents, the mapping being associated with a document structure definition of the subset of document structure definitions and the documents in the mapping complying to the document structure definition.

For example, given a query, to check out which encrypted DTDs are candidate DTDs, for each simple XPath expression derived from the query, it can be matched to a path p, and the hash value can be computed for p using the same hash function HashFunc(p) (Algorithm 1) while creating an index for the DTDs. According to the hash value (i.e., bucket address) returned, the hash table DTDHashTable_{|p|}, see for example FIG. 6, is consulted with the corresponding bucket which gives all the identifiers of DTDs that may possibly contain path p. The rationale for this is straightforward: if path p is present in? the DTD, it will be hashed to the bucket in DTDHashTable_{|p|}, leaving a mark for this DTD in the bucket entry.

### EXAMPLE 9

Suppose a query consists of only one simple XPath expression, corresponding to the path p=(payInfo/creditCard/dueDate). Referring to the DTD indexes shown in FIG. 6, where s=4 and SizeDTDHashTable₂=8, its hash value is computed as follows:
Step a:

ChopName(“payInfo”, 4)=“payI”, ChopName(“creditCard”, 4)=“cred”,

ChopName(“dueDate”, 4)=“dueD”.
Step b:

Base26ValueOf(“payI”)=264272, Base26ValueOf (“cred”)=46751,

Base26ValueOf(“dueD”)=66355.
Step c:

$$HashFunc ( payInfo \text{/} creditCard \text{/} dueDate ) = ( Base 26 ValueOf ( “ PayI ” ) * {10}^{2} Base 26 ValueOf ( “ cred ” ) * {10}^{1} + ase 26 ValueOf ( “ dueD ” ) * {10}^{0} ) mod {SizeDTDHashTable}_{2} = ( 264272 * 100 + 46751 * 10 + 66355 ) mod 8 = 1$$

Due to its hash value 1, it is certain that the example dtd₂ does not contain that path, since the entry at address 1 in DTDHashTable₂ only signifies dtd₁. As a result, only dtd, will be returned as the candidate DTD, dtd₂ and its associated conforming documents can thus be discarded from further consideration.

Step 5 of determining a subset of the collection of documents may comprise a step 25 of looking up, in a mapping from document structure definition to documents, which documents comply to any one of the subset of document structure definitions.

The method of searching in a collection of document may further comprise a step 27 of receiving a certain value associated with the certain branch. The mapping may further comprise an association between a document in the mapping and a value domain partition. Step 5 of determining a subset of the collection of documents may further comprise a step 29 of checking whether a value domain partition associated to a document mapped to the calculated number matches a further value domain partition, the further value domain partition comprising the received value.

The electronic device 31 for searching in a collection of documents in accordance with the invention, see FIG. 10, comprises electronic circuitry 33. The electronic circuitry 33 functionally comprises an input receiver 35, a definition subset determiner 37, a document subset determiner 39, and a searcher 41. The input receiver 35 is operative to receive a certain branch. The definition subset determiner 37 is operative to determine a subset of a collection of document structure definitions, each document structure definition in the subset allowing the certain branch to exist in a document complying to the document structure definition. The document subset determiner 39 is operative to determine a subset of a collection of documents, the subset of documents comprising all documents of the collection of documents complying to any one of the document structure definitions in the subset. The searcher 41 is operative to search for at least part of the certain branch in each document.

The electronic device 31 may be, for example, a computer or a consumer electronic device (e.g. a mobile phone or a personal video recorder). The logic circuitry may be, for example, a general-purpose CPU (e.g. an AMD Athlon or Intel Pentium CPU) operative to run computer programs. Favorably, the input receiver 35, the definition subset determiner 37, the document subset determiner 39, and the searcher 41 are functional components of a computer program. The electronic device 31 may be coupled to an input device 45, e.g. a keyboard or keypad, for entering a certain branch or an expression corresponding to a certain branch, for example. The electronic device 31 may be coupled to an output device 47, e.g. a CRT or LCD monitor, for displaying the search results, for example. The electronic device 31 may comprise a storage means 43. The storage means 43 may comprise, for example, one or more hard disks and/or one or more optical discs. The storage means 43 may comprise, for example, mappings/indexes, document structure definitions (e.g. XML DTDs and/or XML Schemas) and documents (e.g. XML documents). The electronic device 31 may be connected to a computer network comprising one or more electronic devices with storage means for storing one or more mappings/indexes, one or more document structure definitions and/or one or more documents.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Computer program’ is to be understood to mean any software product stored on a computer-readable medium, such as a floppy disk, downloadable via a network, such as the Internet, or marketable in any other manner.

1. A method of searching in a collection of documents, the documents having a tree-like structure and each document in the collection of documents complying with at least one document structure definition in a collection of document structure definitions, comprising the steps of:
receiving (1) a certain branch;
determining (3) a subset of the collection of document structure definitions, each document structure definition in the subset allowing the certain branch to exist in a document complying to the document structure definition;
determining (5) a subset of the collection of documents, the subset of documents comprising all documents of the collection of documents complying to any one of the document structure definitions in the subset; and
searching (7) for at least part of the certain branch in each document.

2. A method as claimed in claim 1, wherein a further step comprises attempting (9) to decrypt each encrypted document in the subset of documents.

3. A method as claimed in claim 1, wherein the step of determining a subset of the collection of documents comprises calculating (21) a number for at least part of the certain branch by applying a hash function to the at least part of the certain branch and looking up (23) which documents are mapped to the calculated number in a mapping from number to documents, the mapping being associated with a document structure definition of the subset of document structure definitions and the documents in the mapping complying to the document structure definition.

4. A method as claimed in claim 3, wherein a further step comprises receiving (27) a certain value associated with the certain branch, the mapping further comprises an association between a document in the mapping and a value domain partition, and the step of determining a subset of the collection of documents further comprises checking (29) whether a value domain partition associated to a document mapped to the calculated number matches a further value domain partition, the further value domain partition comprising the received value.

5. A method as claimed 1, wherein the step of determining a subset of the collection of documents comprises looking up (25), in a mapping from document structure definition to documents, which documents comply to any one of the subset of document structure definitions.

6. A method as claimed in claim 1, wherein the step of determining a subset of the collection of document structure definitions comprises calculating (11) a further number for at least part of the certain branch by applying a further hash function to the at least part of the certain branch and looking up (13) which document structure definitions are mapped to the calculated number in a mapping from number to document structure definitions.

7. A method as claimed in claim 1, wherein the step of determining a subset of the collection of document structure definitions comprises attempting (15) to decrypt each encrypted document structure definition in the collection of document structure definitions and attempting (17) to determine for each document structure definition whether the document structure definition allows the certain branch to exist in a document complying to the document structure definition

8. A computer program product enabling a programmable device to carry out a method as claimed in claim 1.

9. An electronic device (31) for searching in a collection of documents, comprising electronic circuitry (33), the electronic circuitry functionally comprising (33):
an input receiver (35) for receiving a certain branch;
a definition subset determiner (37) for determining a subset of a collection of document structure definitions, each document structure definition in the subset allowing the certain branch to exist in a document complying to the document structure definition;
a document subset determiner (39) for determining a subset of a collection of documents, the subset of documents comprising all documents of the collection of documents complying to any one of the document structure definitions in the subset; and
a searcher (41) for searching for at least part of the certain branch in each document.

10. A method of indexing a collection of documents, the documents having a tree-like structure and each document in the collection of documents complying to at least one document structure definition in a collection of document structure definitions, comprising the steps of:
creating (51) an empty index for each document structure definition of the collection of document structure definitions, the index mapping an integer from a range of integers to a document of the collection of documents;
calculating (53) a number for at least a part of a branch in a document of the collection of documents by applying a hash function to the at least part of the branch, the number being limited to the range of integers and the calculation possibly producing a same number for different branches; and
creating (55) an entry in an index for a document structure definition to which said document complies, the entry comprising a mapping from said calculated number to said document comprising the at least part of the branch.

11. A method as claimed in claim 10, wherein creating an entry in the index comprises associating the document in the mapping to a value domain partition, the value domain partition comprising a value associated with the branch.

12. A method as claimed in claim 10, wherein:
a further step comprises creating (57) an empty further index in which each integer from a further range of integers can be mapped to a document structure definition;
a further step comprises calculating (59) a further number for at least part of said branch by applying a further hash function to said branch, the further number being limited to the further range of integers and the calculation possibly producing a same further number for different branches, and
a further step comprises creating (61) an entry in the further index, the entry in the further index comprising a mapping from the calculated further number to said document structure definition to which said document complies.

13. A computer program product enabling a programmable device to carry out a method as claimed in claim 10.

14. An electronic device (71) for indexing a collection of documents, comprising electronic circuitry (73), the electronic circuitry (73) functionally comprising:
an index creator (75) for creating an empty index for each document structure definition of a collection of document structure definitions, the index mapping an integer from a range of integers to a document of the collection of documents;
a hash calculator (77) for calculating a number for at least a part of a branch in a document of the collection of documents by applying a hash function to the at least part of the branch, the number being limited to the range of integers and the calculation possibly producing a same number for different branches; and
an index filler (79) for creating an entry in an index for a document structure definition to which said document complies, the entry comprising a mapping from said calculated number to said document comprising the at least part of the branch.
